(19) United States
(12) Patent Application Publication
(10) Pub. No.: US 2014/0235213 A1
(43) Pub. Date: Aug. 21, 2014

(54) Terminal based interactive voice response system with information prioritization

(71) Applicant: Nickelback OU, Tallinn (EE)

(72) Inventor: Timo Esko Engström, Tallinn (EE)

(73) Assignee: Nickelback OU, Tallinn (EE)

(21) Appl. No.: 14/126,018

(22) PCT Filed: Jun. 15, 2012
(86) PCT No.: PCT/IB2012/001163

§ 371 Date: Mar. 17, 2014

(30) Foreign Application Priority Data
Jun. 15, 2011 (EE) P201100045

(51) Int. Cl. H04M 3/533; H04W 4/12

(52) U.S. Cl. CPC H04M 3/5335; H04W 4/12
USPC 455/413

(57) ABSTRACT

The aim of the invention is to provide a terminal based interactive IVR system, where the IVR functionality is served by the terminal, which allows a user of the IVR system to create personal action tree for each individual caller or also caller group, where the action tree can be created and maintained via the terminal itself and also a remote configuration, storage and/or synchronization facility in the data communication network. Also the caller is allowed to enter the priority information to the transferable message. The terminal based interactive IVR system comprises a terminal, which is equipped with the keyboard, display, sound unit and memory unit, where to keep both the terminal based interactive IVR system, at least one action tree and the messages to be played to the caller. Also, the terminal comprises with the means to communicate with the remote configuration, storage and/or synchronization facility, which is also equipped with the means to create, modify, delete, synchronize, store and restore the terminal based interactive IVR action tree with the response data. The action trees describe the different actions of the IVR system based, taking also the caller assigned priority information into account. Further customized functionalities can be added to the system.

### FIELD OF THE INVENTION

This invention relates to terminal based interactive voice response (IVR) system, which refers to a such a solution where the server functionality that handles the incoming calls runs inside a smart device, such as smartphone or tablet computer, which has the ability to allow the user of the terminal based interactive IVR system to prioritize the transferable message.

### PRIOR ART

IVR systems are well known from the telephone networks, where the caller after reaching the IVR function in the server, is requested to use phone keys to respond to IVR's requested options, e.g. to press “1” in order to be connected to network terminal of a person “A” etc. Such a solution is used in the core of the phone network, and in addition'of being costly, is very limited in different options the final destination number holder may request from the IVR. Also, in the server based IVR systems the user has limited access to the functions of the system, and the system is configured and changed by the system administrator or owner.

Terminal based IVR systems are known (U.S. Pat. No. 7,881,285, published Jan. 2, 2011; JP2002204300, published 19 Jul. 2002), where the IVR functionality is located on the terminal device, which may also be a mobile terminal. In known solutions the incoming call is responded by the IVR functionality in a way which is pre-configured in the terminal device. It is common to have different responses based on the caller's identification number (ID) in the contact list of the terminal device, based on number belonging to a predefined group or alike. Also, it is known that IVR functionality can be divided into modules and sub-modules, and these modules can be downloaded by the terminal owner based on the required functionality.

A know terminal based interactive IVR system's solution is provided by the company Mobisophy Technologies (with a software based solution of “Interactive Voice Call Master for S60”) which also allows creation and storage of some profiles with the IVR's responses to different callers based on e.g. caller groups.

A solution for enhancing processing priority, implementing interactive service and implementing customized IVR flow is known from patent application KR20100047150 (published May 7, 2010), where the central system is able to provide a subscriber a customized IVR tree, after some prior information about the subscriber is received by the central system, where the processing priority level can be changed.

A solution for automating IVR system interaction is known from patent application WO 2009/079252 (published 25 Jun. 2009), where the user terminal receives the menu tree of the IVR system from the server or remote database and based on the visual menu tree the user can interact with the IVR system's in the server. The system also updates the menu tree on the user terminal according to changes made in the IVR system's server.

Currently known terminal based interactive IVR solutions are not able to provide the full structure of the IVR system to be created and maintained both in the terminal and in the remote configuration, storage and/or synchronization facility located in some data communication network (e.g. Internet), also the caller has been given only trivial control over the actions requested by the IVR and the caller is not able to prioritize the transferable message.

### DETAILED DESCRIPTION OF THE INVENTION

The aim of the invention is to provide a terminal based interactive IVR system, which allows a owner of the IVR system to create at least one personal action tree for each individual caller, where the action tree can be created and maintained via the terminal itself and also a remote configuration, storage and/or synchronization facility in the data communication network. Also there can be more than one action tree defined per each caller. In addition, the caller has the possibility to assign different priorities to the message about to be transferred. Actions in the terminal based interactive IVR system are carried out according to action tree.

The remote configuration, storage and/or synchronization facility comprises storage area and network communication unit.

The terminal based interactive IVR system contains a terminal, which is equipped with the input unit such as a keypad, display, sound unit and a memory unit, where to keep and run the IVR system, at least one action tree and the messages to be played to the caller. Also, the terminal is equipped with the means for communication with the remote configuration, storage and/or synchronization facility, which is also equipped with the means to store and create the IVR action tree with the response data, therefore in the terminal based IVR system the IVR functionality is served by the terminal. The communication between the terminal and the remote configuration, storage and/or synchronization facility can be automated.

The terminal based interactive IVR system is equipped with the functionality of at least answering the incoming call, responding to the caller, reading the keypad readings and also the functionality, by what the caller is made possible to interact freely with the IVR system, and besides the common received call greeting, made possible to assign additional prior information about the transferable message, e.g. while the terminal based interactive IVR system has responded to the caller on behalf of the user, then the caller can assign the priority level to the message, such that based on the priority information the terminal based interactive IVR system can be equipped with such a decision tree, that the message can be handled by different means and not only classified based on the value of the caller's ID. System can be equipped with the additional customized functionality.

Moreover, additional criterias set by the user can be used for affecting the behaviour of the action tree, specially in cases where more than one action tree exists per caller. Additionally one and more code words are defined in the terminal based interactive IVR system, which are known to the user of the terminal based interactive IVR system, but not offered to caller by the terminal based interactive IVR system itself, and which have user definable meanings, in the terminal based interactive IVR system, and also a part or the entire action tree can be hidden to the caller.

Among other tasks the remote configuration, storage and/or synchronization facility in the data communication network is allowing creating, modifying, deleting, syncronizing, storing and restoring the action trees for the terminal based interactive IVR system, and exchanging them with the terminal via communication unit. The creation of one and more action trees in the terminal based interactive IVR system can be handled by the user per each caller independently, while also allowing the user of the terminal based interactive IVR system to create the action tree for several callers in a single step.

The structure of the entire terminal based interactive IVR system can be modular, by involving at least one module.

The caller in the terminal based interactive IVR system can be understood to be as an individual person who is calling or also belonging to a group of persons. Therefore it would be possible to have action trees also covering the caller groups.

### BRIEF DESCRIPTION OF THE FIGURES

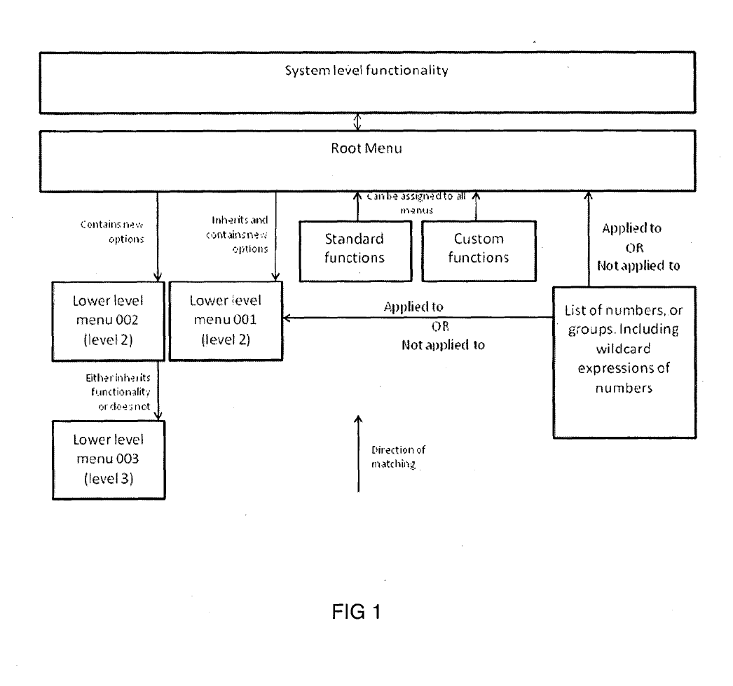

On the FIG. 1 an overall logical structure of the invention is depicted, comprising system level functionality, root menu with optional submenus, standard functions, custom functions and list of numbers and groups including wildcard expressions of numbers.

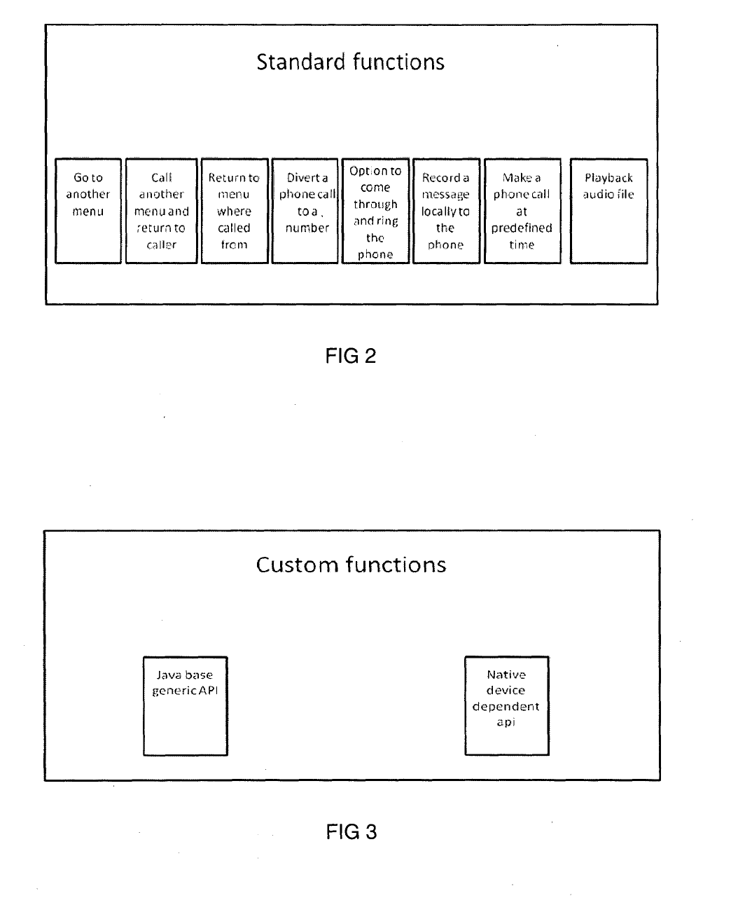

On the FIG. 2 standard functions of the invention are shown in greater detail: comprising “go to other menu”, “call another menu and return to caller”; “return to menu where called from”; “divert phone call to a number”; “option to come through and ring the phone”; “record a message locally to the phone”, “make a phone call at predefined time”, “playback of audio file”.

On the FIG. 3 custom functions are shown, including Java based generic API (Application Programming Interface), and a native device dependent API.

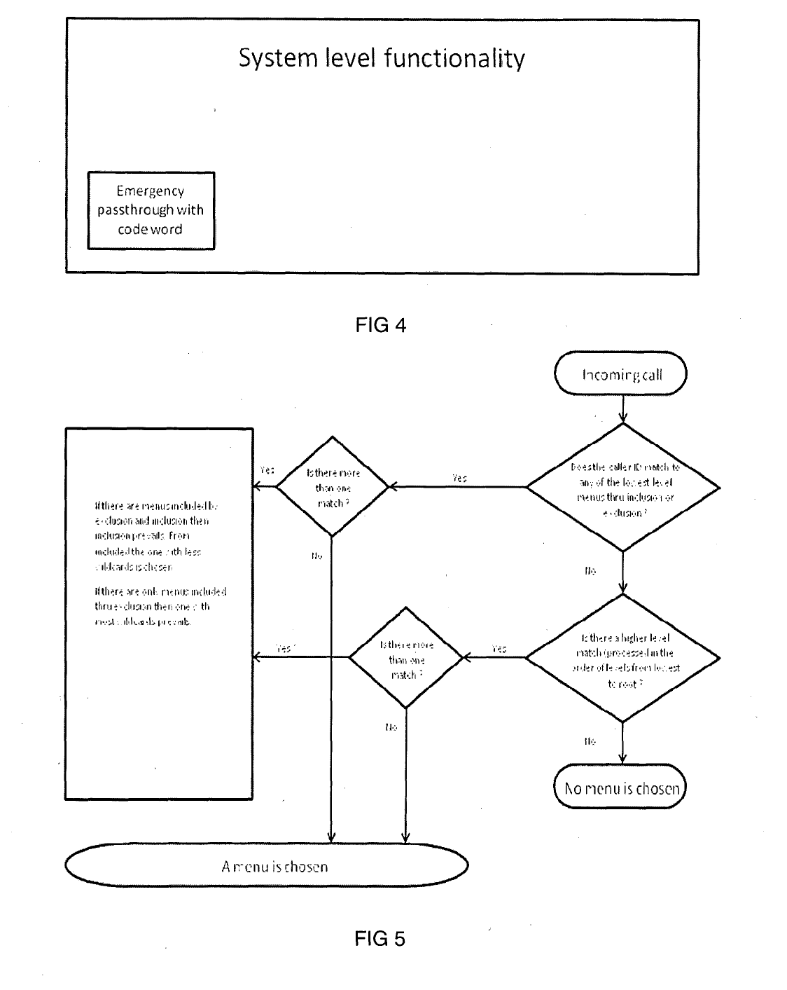

On the FIG. 4 the system level functionality with emergency passthrough with code word is described.

On the FIG. 5 the generic flowchart about logic of matching to menus is given.

### DETAILED DESCRIPTION OF THE PREFERRED EMBODIMENTS

Below the detailed description of the preferred embodiments is given.

The terminal based interactive IVR system comprises a terminal, which is equipped with the input unit such as keypad, display, sound unit and a memory unit, where the terminal based interactive IVR system functionality and its submodules, with at least one action tree and the messages to be played to the caller, are located and served from. Also, the terminal is equipped with the means for communicating with the remote configuration, storage and/or synchronization facility, which in turn is also equipped with the means to create, modify, delete, syncronize, store and restore the terminal based interactive IVR system's action trees with the response data. The terminal is equipped with the means to communicate with the caller.

In the current preferred embodiment the terminal based interactive IVR system is based on the system level functionality which in turn exchanges information with the root menu. The root menu is firstly capable of verifying the caller's number's match against the known list of numbers or groups (including wildcard expressions with numbers, there can also be more than one exact match on a caller ID where the correct one will be determined i.e. by call recipients timezone, geographic location, chosen phone profile etc.), secondly it interacts with standard functions and custom functions, while all of them can be assigned to all submenus. The custom functions are constructed of Java based generic API (Application Programming Interface) and native device dependent API. The root menu may comprise also submenus. In the current preferred embodiment the root menu comprises two levels of submenus: lower level submenus and their child menus. The lower level submenus and child menus are assigned to caller during the call for entering requested information through the terminal's keypad. The lower level menus can receive amendments to their structures from the root menu during the call and based on the caller assigned information including the priority level of the transferable message. The user has the ability to navigate through the action tree assigned to a caller also during the session in progress.

The terminal based interactive IVR system comprises with the functionality of at least answering the call, responding to the caller, reading the keypad readings and also the functionality, e.g. while the terminal based interactive IVR system has responded to the caller on behalf of the user, that the caller can assign the priority level to the message, such that based on the priority information the terminal based interactive IVR system comprises with such a decision tree, that the message can be handled by different means and not only classified based on the caller's ID value (there can be other user defined criterias taken into consideration when the action tree is used). As an example of four level of priorities of the message, the terminal based interactive IVR system can record the voice message of the caller in case the fourth (lowest) priority level information is entered by the caller, will beep shortly the terminal's sound unit and then record the message to the terminals memory after predefined time in case the third priority level is assigned by the caller; ring loudly the sound unit of the terminal and after some time record the message, and then after predefined time the sound unit of the terminal is still activated for user's attendance in case the second priority is assigned by the caller; to activate the sound unit of the terminal automatically after defined time and allow the user to hear the voice message immediately. At all instances the user has the ability to amend and/or navigate the action trees of the terminal based interactive IVR system during the session in progress, so that the final action may be different from the action of what would have occurred according to the predefined action tree.

The remote configuration, storage and/or synchronization facility in the data communication network is mostly used for creating the action trees for the terminal based interactive IVR system and maintaining them and synchronising them with the terminal, and also allowing the terminal to initiate synchronisation with the remote configuration, storage and/or synchronization facility.

In the second preferred embodiment the selected caller has been given a user defined code word by the user of the terminal based interactive IVR system, where the code word has been assigned (on the system level functionality) a specific action by activating the sound unit of the terminal immediately and at the same time this code word is not published to caller by the same communication means which is used between the caller and the terminal based interactive IVR system. While the caller is calling to the user of the terminal based IVR system and is entering the code word by keypad, then the sound unit of the user's terminal is activated and the voice message of the caller is played to user. The alternative way of realising the described scenario would be creating a partly or fully hidden action tree.

Additionally there is an option of a system level pass through code word which allows the caller to come through regardless of the active action tree.

1. Terminal based interactive voice response system with information prioritization, comprising the IVR system on the terminal device with the functionality of at least answering the call, responding to the caller and reading the input unit's such as keypad insertions; the terminal device comprises at least memory unit, display unit, input unit, sound unit and the communication unit; the action in the system is carried out according to action tree; the system is characterised in that it comprises means allowing terminal based IVR system to interact with the caller dynamically and allowing the caller to assign different values of priority level to the transferable message prior transmission of the message; comprising at least one module and allowing the processing of inserted information by at least one module; the action tree is individually personalised and assigned to at least one caller and a caller has at least one action tree assigned to; means allowing action tree or parts of it to be hidden; an additional criteria which is used for selecting the action tree if more than one exists per caller can be applied by user; comprises system level pass through code word which allows the caller to come through regardless of the active action tree; system comprises also customized functionality that can be added to the system; comprises remote configuration, storage and/or synchronization facility on the data communication network, the remote configuration, storage and/or synchronization facility comprises storage area and network communication unit; the terminal is adjusted to communicate with the remote configuration, storage and/or synchronization facility; the action tree can be created and maintained both through the terminal and through the remote configuration, storage and/or synchronization facility.

2. System according to claim 1, characterised in that caller is a single person.

3. System according to claim 1, characterised in that caller is a group of persons.

4. System according to claim 1, characterised in that it comprises creation of one and more action trees in the terminal based interactive IVR system per each caller by the user independently.

5. System according to claim 1, characterised in that it comprises means allowing the user of the terminal based interactive IVR system to create the action tree to several callers in a single step.

6. System according to claim 1, characterised in that it comprises automated means of transporting the action tree information between the remote configuration, storage and/or synchronization facility and the terminal.

7. System according to claim 1, characterised in that it comprises means to navigate the action trees assigned to caller based on the information provided by the caller during the session in progress.

8. System according to claim 1, characterised in that it comprises means to amend the action trees assigned to caller based on the information provided by the caller during the session in progress.

9. System according to claim 1, characterised in that the remote configuration, storage and/or synchronization facility allowing to create, modify, delete, syncronize, store and restore action trees and exchanging action trees with the terminal via communication unit.

10. System according to claim 1, characterised in that the custom functions are constructed of Java based generic API (Application Programming Interface) and native device dependent API.
